(19) United States
(12) Patent Application Publication
(10) Pub. No.: US 2007/0036609 A1
(43) Pub. Date: Feb. 15, 2007

(54) Page protector

(76) Inventor: Curt D. Seymour, Parkville, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/340,237

(22) Filed: Jan. 25, 2006

Related U.S. Application Data
(60) Provisional application No. 60/647,042, filed on Jan. 25, 2005.

(51) Int. Cl. B42F 13/00

(52) U.S. Cl. 402/79

(57) ABSTRACT

A page protector for scrapbooks, photo albums and the like is provided. The page protector includes a spine with a thickness that is greater than the thickness of the page portion of a page protector. The thickened spine prevents undesirable bulging of the pages of the book caused by the inclusion of three-dimensional objects on the pages, and provides an aesthetically pleasing spine appearance for the book.

This application claims priority pursuant to 35 U.S.C. 119(e) to co-pending U.S. Provisional Patent Application Ser. No. 60/647,042, filed Jan. 25, 2005, the entire disclosure of which is incorporated herein by reference.

### FIELD OF THE INVENTION

The present invention relates generally to page protectors for scrapbooks, photo albums, and the like. More specifically, the present invention is concerned with thickened-spine page protectors to accommodate placement of three-dimensional objects on pages of scrapbooks, photo albums, and the like.

### BACKGROUND OF THE INVENTION

Scrapbooking is an extremely popular hobby that has grown significantly in recent history. Scrapbooking is a craft that involves creatively adhering photographs and other mementos to pages in an album or scrapbook, along with information about the photos to create a lasting display of a person's or family's history. Historically, scrapbooks included photographs, newspaper clippings, drawings, writings, and other generally flat two-dimensional items. In recent years the artistic creativity of scrapbook pages has evolved significantly in large part due to the offering of a wide variety of scrapbooking papers, stickers, and other embellishments that are used to decorate the pages. This evolution of creativity has transformed scrapbooking from a generally two-dimensional art form to a three-dimensional art form. Three-dimensional scrapbooking accessories include three dimensional stickers, charms, buttons, tacks, brads, etc. In addition, many mementos that scrapbookers wish to display on scrapbook pages are three-dimensional, such as medals, ribbons, etc.

Most scrapbooks today usually include a number of removable pages that allow the scrapbooker to remove the empty page from the scrapbook, create the desired display on the page and then return the completed page to the scrapbook. In addition, the scrapbooker can add pages to or remove pages from the scrapbook as desired for the particular book being designed. These removable/insertable pages generally include a clear plastic page protector that surrounds a paper or card-stock insert on which the display is created. The page protector includes a spine that is pre-punched (or which can be punched) to allow placement of the page within the binding of the scrapbook. Scrapbooks that are designed for removable/insertable pages generally include a ring or post binding to accept placement of the punched spine. Ring bound scrapbooks generally have a fixed spine thickness due to the nature of ring binders. Alternatively, post bound scrapbooks generally have a spine thickness that will vary depending upon the amount of pages being held within the binder.

The trend towards three-dimensional page layouts for scrapbooks results in scrapbook page sections that bulge well beyond the thickness of the spine of the scrapbook, such that the scrapbook has a generally bulging, overfilled appearance. This bulged, overfilled appearance is particularly noticeable and undesirable on post bound scrapbooks, in which the spine of the scrapbook ends up significantly thinner than the page portion of the scrapbook. To overcome this undesirable appearance, many scrapbookers will add spacers to the spine of the scrapbook between the pages to add thickness to the spine. These spacers, which are generally sold by scrapbook supply companies, normally consist of narrow corrugated cardboard strips that are pre-punched (or which can be hole-punched) to slide on the posts of the scrapbook. Although these cardboard spacers alleviate the undesired bulging problem, they result in a discontinuous, unattractive appearance for the spine of the scrapbook, and are time consuming for the scrapbooker to assemble. Therefore, it would be beneficial to provide a means to accommodate the use of three-dimensional layouts on scrapbook pages that prevents undesirable bulging of the finished scrapbook, that results in an aesthetically pleasing spine appearance, and which provides easy assembly.

### SUMMARY OF THE INVENTION

An object of the present invention is to accommodate the use of three-dimensional layouts on scrapbook pages and the like (referred to herein generally as “scrapbook(s)”) while preventing undesirable bulging of the finished scrapbook. Another object of the instant invention is to prevent undesirable bulging of the scrapbook while simultaneously providing an aesthetically pleasing spine appearance. Yet another object of the instant invention is to provide a means of preventing undesirable bulging of the scrapbook that is easy to assemble.

The objects of the instant invention are accomplished through the use of a page protector that includes a spine thickness that is greater than the thickness of the page portion of the page protector. In post-bound albums and scrapbooks in particular, this increased thickness for the spine of the page protector increases the overall thickness of the spine of the book, so that three-dimensional layouts can be displayed on the pages of the book without creating an undesirable bulge of the page portion of the book beyond the spine of the book. The spine of the instant invention may be manufactured and sold in a variety of thicknesses, such as 1 mm spine, 2 mm spine, 3 mm spine, etc., to allow the end consumer to use a thickness appropriate to accommodate the specific three-dimensional items being displayed on the pages without resulting in too thick or too thin a spine for the entire book.

A conventional page protector is manufactured from a single piece of an extruded plastic material that is folded along a side edge, and is heat-sealed along the bottom and other edge to form a two-layer sleeve or pocket (one layer of material on each side of the pocket) that surrounds the paper or card stock that is to be protected. The pocket is sealed off from the spine of the page protector through the use of spot welds to prevent the paper or card stock from coming into contact with the binding of the book. This prevents damage to the paper or card stock that could be caused by turning the pages in the book. The spine section and the page section of the conventional page protector, having been made from a single piece of material, will both have equal thicknesses. The spine section is punched, typically with two or three holes (or more), to align with the posts/rings of book or album for which it is to be inserted. In some cases the spine is pre-punched during manufacture, or alternatively, the spine may be punched by the consumer.

Although it will be appreciated that page protectors of the instant invention may be manufactured to have a spine portion that is made of a material that is thicker than the material used to make the page portion of the protector, the preferred embodiments of the instant invention utilize thickened spines that are made of multiple layers of material. This simplifies the manufacturing process as it allows the page protectors of the instant invention to be manufactured in the same manner as conventional page protectors with the additional layers added to increase the thickness of the spine.

In one preferred embodiment of the instant invention, the spine thickness is accomplished through the use of a spacer that is located within a pocket located in the spine of each individual page protector. In one embodiment the spacer of the instant invention is made of a generally clear, generally transparent material, such as plastic or plexi-glass or any other suitable material, to match the appearance of the generally clear, generally transparent plastic from which the page protector itself is manufactured. This provides a consistent, aesthetically pleasing appearance to the spine of the book. In alternative embodiments, the spacer is made of a material that is colored (may be either transparent or non-transparent) to provide an aesthetically pleasing custom-color for the spine of the book. The non-transparent, colored spacer of the instant invention may be made of any material suitable to provide the desired thickness and appearance, such as metal, plastic, cardboard, paper, wood, etc. The spacer of the instant invention may be inserted within the pocket of the page protector during manufacturing so that the end consumer is not required to assemble individual page protectors, thereby reducing assembly time of a scrapbook (or other similar album/book) in which a thickened spine is desired.

In an alternative embodiment of the instant invention, a generally clear, generally transparent or otherwise custom-colored spacer, as is discussed above, is utilized in the same manner as the corrugated spacers of the prior art. In such an embodiment, the clear or custom-colored spacer is placed between individual page protectors of a scrapbook (or other similar album/book). Although this requires considerably more assembly time for an end user of the inventive page protector, the spacer of the instant invention provides an aesthetically pleasing appearance to the spine of the scrapbook in the same manner discussed above with the embodiment in which the spacer is located within a pocket in the spine of the scrapbook.

If holes are punched in the spine of the page protector during manufacture, the spacer may be die-cut or otherwise punched such that the holes in the spacer will align with the holes in the spine of the protector, or alternatively, the holes in the spacer may be punched simultaneously with the holes in the spine, if the spacer is assembled to the page protector (such as being inserted in the spine pocket) during manufacture.

In yet several other preferred embodiments of the instant invention, the spine thickness is accomplished through the use of thickening material, or additional layers, that is/are attached to the outer surface of the spine of the conventional page protector. Such additional layer(s) may be attached to the outer surface of the spine of the page protector by a heat seal, glue, a mechanical bond (such as a separate mechanical fastener, snap connect built into the additional layer(s) and/or the spine of the page protector), or any other form of attachment now known or hereinafter discovered. As is discussed above with the embodiments of the instant invention that utilize a spacer, the additional layer(s) of these embodiments may be provided in a variety of colors or be transparent to provide a variety of aesthetically pleasing appearances.

In one embodiment, in which layer(s) are added to the exterior of a conventional page protector, the spine thickness is accomplished by a hinge that is sandwiched around the exterior surface of the spine of the page protectors. The hinge may be made of any suitable material. In one embodiment, the hinge is made of a plastic material that is heat-sealed to the page protector during production. Alternatively, the hinge can be glued, or mechanically attached, or otherwise sealed to the page protector by the end user who purchases the hinge separately from the page protectors, or as part of a kit with the page protectors. As is discussed above with respect to the spacers, the hinge may be provided in a variety of thicknesses.

In other alternative embodiments of the instant invention layer(s) are added to the exterior of a conventional page protector, the layers may be formed from the same or similar material that the page protector is manufactured. These layers may be heat sealed or spot welded together in the same manner used in connection with manufacturing the conventional page protector, or they may be glued, bonded, or mechanically attached together through other suitable means. The layers may be a plurality of individual separate strips sealed together to a desired thickness or separate multi-layered strips sealed together to a desired thickness. Alternatively, the layers may be made from the same material from which the page protector is made, and at the same time, by folding the material several times at the spine of the page protector and then heat sealing the layers together. As has already been discussed above with respect to other embodiments of the instant invention, all of these embodiments may utilize materials of a variety of colors, and may be either transparent or non-transparent depending upon the desired appearance for the spine of the book in which they are to be used.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

Preferred embodiments of the invention, illustrative of the best mode in which the applicant has contemplated applying the principles, are set forth in the following description and are shown in the drawings and is particularly and distinctly pointed out and set forth in the appended claims.

FIG. 1 is a perspective view of a conventional page protector which is utilized in an embodiment of the thickened-spine page protector of the instant invention.

FIG. 1b shows a spacer of the instant invention adapted for placement within a pocket formed in the spine of the page protector shown in FIG. 1.

FIG. 1c shows the spacer of FIG. 1b located within the pocket in the spine of the page protector of FIG. 1.

FIG. 2a shows an embodiment of the instant invention in which a hinge is placed around the exterior spine of a conventional page protector.

FIG. 2b shows the hinge of FIG. 2a after it is attached to the page protector.

FIG. 3 shows an embodiment of the instant invention in which multiple strips of material are attached to the spine of a convention page protector.

FIG. 4 shows an embodiment of the instant invention in which the thickened spine is made by making multiple folds of the material from which a conventional page protector is made at the spine of the page protector as it is being manufactured.

FIG. 5 shows an embodiment of the instant invention in which multiple multi-layered strips of material are attached to the spine of a conventional page protector.

### DETAILED DESCRIPTION OF PREFERRED EMBODIMENTS

As required, detailed embodiments of the present invention are disclosed herein; however, it is to be understood that the disclosed embodiments are merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

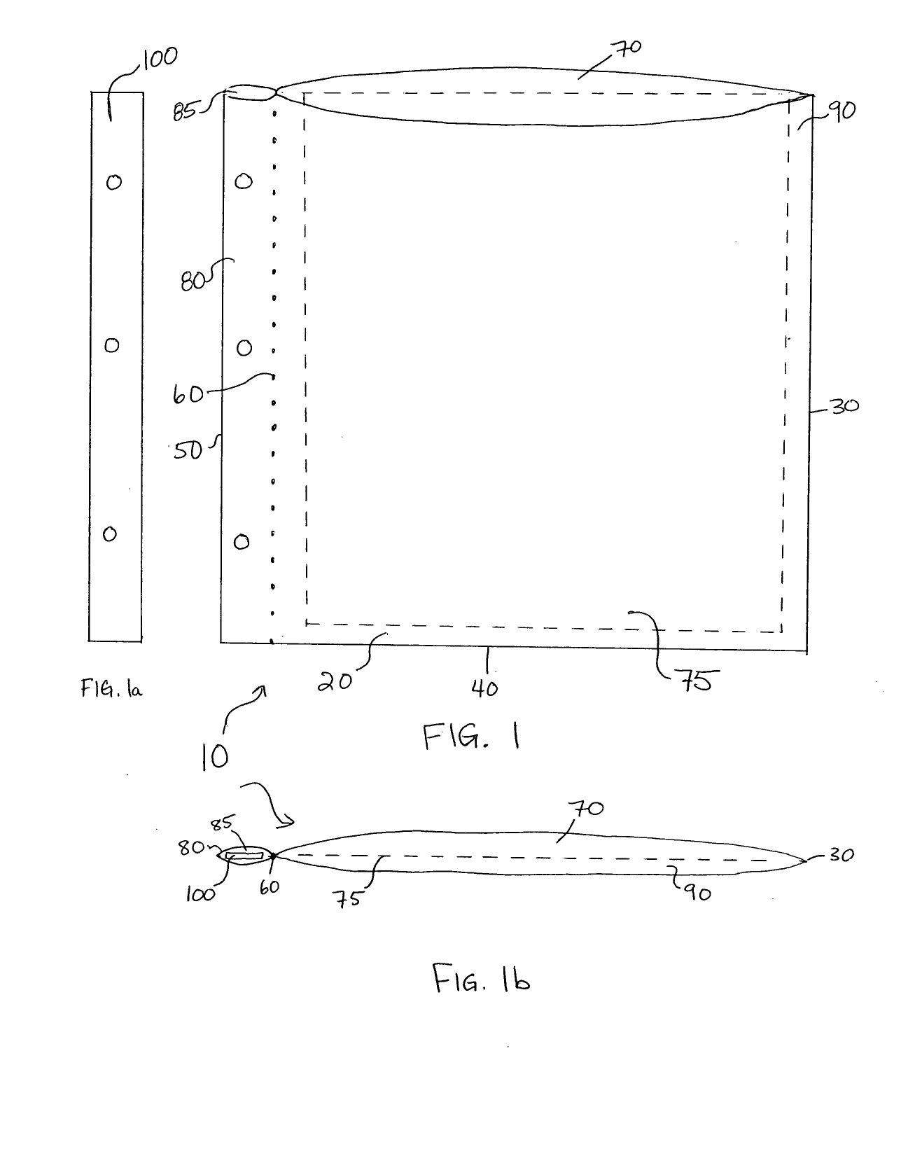

The invention generally comprises a page protector that includes a spine thickness that is greater than the thickness of the page portion of the page protector. Referring to FIG. 1-FIG. 1c page protector 10 exemplifying an embodiment of the present invention is shown which includes spine section 80 and page section 90. Page protector 10 is manufactured from a single piece of extruded plastic material 20 that is folded along edge 30, and heat-sealed along bottom 40 and edge 50 to form two-layer sleeve or pocket 70. One layer of material 20 is located on each side of the front and back sides of pocket 70 to surround paper or card stock 75 that is inserted in pocket 70 to be protected. In a preferred embodiment, as is done with conventional page protectors, pocket 70 is sealed off from the spine of page protector 20 through the use of spot welds 60 that connect the front and back layers of material 20 together to prevent paper or card stock 75 from coming into contact with the binding of scrapbook 20. In a preferred embodiment, bottom 40 is heat sealed across the bottom of both page section 90 and spine section 80 for easier manufacture.

Spacer 100 is located within pocket 85 in spine section 80 (illustrated in FIG. 11c) to allow for the desired spine thickness. Referring to FIG. 1b, spacer 100 can be manufactured using various materials including, but not limited to, plastic, plexi-glass, metal, cardboard, paper, wood or other material to create the desired effect. In a preferred embodiment, spacer 100 is inserted within spine pocket 85 of page protector 10 during manufacturing so that the end consumer is not required to assemble individual page protectors 10, thereby reducing assembly time of a scrapbook in which a thickened spine is desired. Spacer 100 may then be sealed within, welded, or otherwise connected to pocket 85 such that the assembly is permanent, or alternatively, spacer 100 may be removable from and reinsertable into pocket 85 to allow a variety of thickness options. In one embodiment, several spacers of varying thicknesses may be provided with a page protector to allow the end user to customize a desired thickness for each page protector.

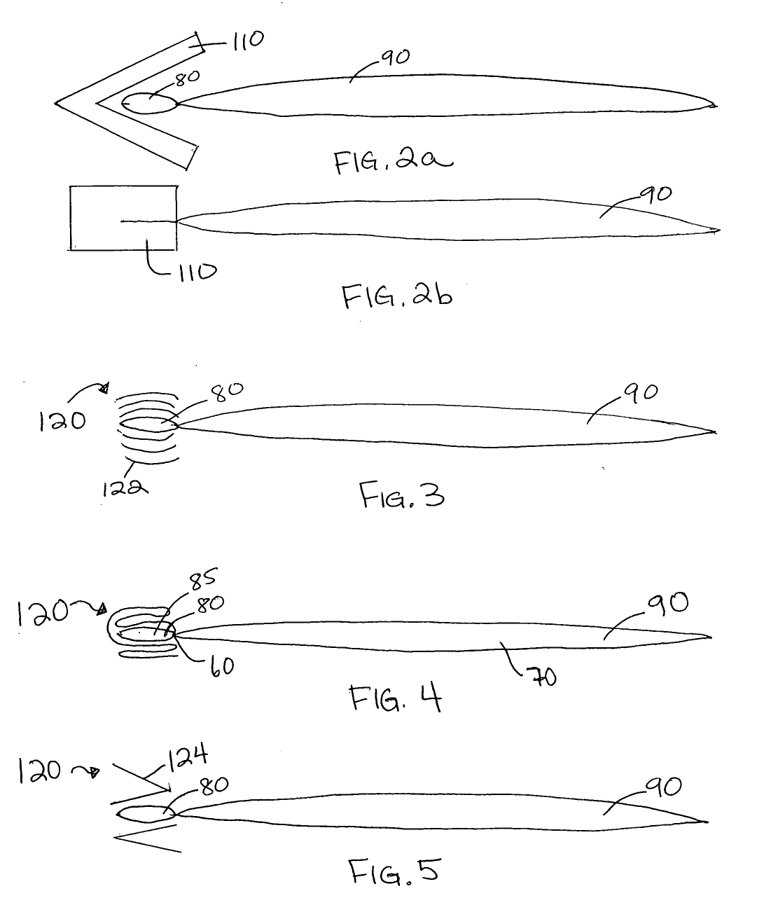

Referring to FIG. 2a, layer(s) are added to the exterior of page protector 10 and the spine thickness is accomplished by hinge 110 that is sandwiched around the exterior surface of spine section 80. FIG. 2b illustrates the hinge 110 in a closed position around spine section 80. Hinge 110 can be made of plastic, metal, plexi-glass, or any other suitable material, and may be assembled to page protector 10 during manufacture or after purchase by the consumer. Additionally, hinge 110 can be provided in a variety of thicknesses so that the desired size of spine section 80 may be customized. It will be appreciated that hinge 110 may be utilized with or without spot welds 60 in page protector 10, as the hinge itself will separate pocket 70 from the binding.

Referring to FIGS. 3 through 5, layer 120 or multiple layer(s) 120 are added to the exterior of page protector 10. Layers 120 may be formed from the same or similar material as page protector 10 itself. Layers 120 may be heat sealed or spot welded together in the same manner used in connection with manufacturing page protector 10, or they may be glued, bonded, or mechanically attached together through other suitable means. Referring to FIG. 3, layers 120 are a plurality of individual separate strips 122 sealed together to a desired thickness. Referring to FIG. 4, layers 120 are made from the same sheet of material as page protector 10, and at the same time. Page protector 10 of the embodiment in FIG. 4 is constructed by folding a sheet of material and heat sealing the bottom and side edges in the manner discussed in connection with FIG. 1, however, instead of being folded in half, or cutting off excess material at the spine edge (reference no. 50 in FIG. 1), the material is folded such that excess material extends beyond the spine edge of page protector 10 on at least one of the front or back side of page protector 10. Page protector 10 is then spot welded (at 60) creating separate page pocket 70 and spine pocket 85. The thickened spine is formed by folding over the extra material several times at spine section 80 of page protector 10 and then heat sealing layers 120 together. Referring to FIG. 5, the layers 120 are separate multi-layered strips 124 sealed together to a desired thickness. As is shown in FIG. 5, the multi-layered strips are formed by folding over a single layered piece of material to result in two layers.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A page protector comprising:
a page portion; and
a spine portion associated with said page portion, said spine portion having a thickness generally greater than a thickness of said page portion.

2. The page protector as claimed in claim 1 wherein said thickness of said spine portion comprises a thickening spacer associated with said spine portion.

3. The page protector as claimed in claim 2 wherein said spacer includes pre-punched holes.

4. The page protector as claimed in claim 3 where said holes are die-cut in said spacer.

5. The page protector as claimed in claim 2 wherein said spacer is insertable into a pocket within said spine portion.

6. The page protector as claimed in claim 5 wherein said spacer and said page protector are sold as a kit including multiple spacers of varying thicknesses.

7. The page protector as claimed in claim 2 wherein said spacer is connected to an exterior surface of said spine portion.

8. The page protector as claimed in claim 7 wherein said spacer comprises a hinge sandwiched about said spine portion.

9. The page protector as claimed in claim 7 wherein said spacer comprises multiple layers of material connected together.

10. The page protector as claimed in claim 1 wherein said spine portion includes pre-punched holes.

11. The page protector as claimed in claim 1 wherein said page protector further comprises:
a front layer; and
a back layer adjoined to said front layer along least at one edge to form at least one pocket adapted for insertion of a page, a portion of said at least one pocket comprising said spine portion and another portion of said at least one pocket comprising said page portion.

12. The page protector as claimed in claim 11 wherein said at least one pocket comprises a line of spot welding of one said front layer to said back layer to create a spine pocket and a page pocket.

13. The page protector of claim 12 wherein a thickening spacer is inserted with said spine pocket.

14. A spacer for use with pages of a scrapbook, album, binder, or the like, said spacer comprising:
a strip of material including a height generally equal to a page height, a width generally equal to a width of a spine of the page and a thickness;
wherein said strip of material is generally transparent.

15. The spacer as claimed in claim 14 wherein said strip includes pre-punched holes.

16. A spacer for use with pages of a scrapbook, album, binder, or the like, said spacer comprising:
a strip of material including a height generally equal to a page height, a width generally equal to a width of a spine of the page and a thickness;
wherein said strip of material comprises a color adapted to created a custom color for a spine of the scrapbook, album, binder, or the like.

17. The spacer as claimed in claim 16 wherein said strip includes pre-punched holes.
